(19) United States
(12) Patent Application Publication
(10) Pub. No.: US 2026/0211976 A1
(43) Pub. Date: Jul. 23, 2026

(54) METHOD AND ELECTRONIC DEVICE FOR GENERATING TRAINING DATA FOR PREFERENCE OPTIMIZATION TRAINING

(71) Applicant: SAMSUNG ELECTRONICS CO., LTD., Suwon-si (KR)

(72) Inventors: Wongoo HAN, Suwon-si (KR); Jinseok SON, Suwon-si (KR)

(73) Assignee: SAMSUNG ELECTRONICS CO., LTD., Suwon-si (KR)

(21) Appl. No.: 19/462,601

(22) Filed: Jan. 28, 2026

Related U.S. Application Data
(63) Continuation of application No. PCT/KR2026/001242, filed on Jan. 21, 2026.

(30) Foreign Application Priority Data
Jan. 23, 2025 (KR) 10-2025-0010660

(51) Int. Cl. G06F 18/214; G06N 3/0475; G06N 3/09

(52) U.S. Cl. CPC G06F 18/2148; G06N 3/0475; G06N 3/09

(57) ABSTRACT

A method of generating training data for preference optimization training, includes performing, by using a first generative model, inference a predefined number of times by inputting a same input sequence into the first generative model the predefined number of times; evaluating, by using a second generative model, a preference for an inference result of the first generative model; based on an evaluation result of the evaluating, selecting, from the inference result, a plurality of response pairs, each of the plurality of response pairs comprising a non-preferred response and a preferred response; and generating training data by processing the plurality of response pairs.

### CROSS-REFERENCE TO RELATED APPLICATIONS

This application is a continuation of International Application No. PCT/KR2026/001242, filed on Jan. 21, 2026, which claims priority to Korean Patent Application No. 10-2025-0010660, filed on Jan. 23, 2025 in the Korean Intellectual Property Office, the disclosures of each of which are incorporated by reference herein their entirety.

### BACKGROUND

### 1. Field

The disclosure relates to a method and electronic device for generating training data for preference optimization training.

### 2. Description of Related art

Artificial intelligence (AI)-based technologies have been utilized in various fields across industries. Various AI models have been developed and utilized in respective fields, and the number of cases where AI-based solutions are applied has rapidly increased, not only in manufacturing but also in various industries, such as robotics, transportation/logistics, healthcare, education, and pharmaceuticals/biotechnology. The introduction of AI-based technologies has led to enhanced competitiveness for companies and countries.

Generative AI technologies have been widely used in various fields, such as summarizing text, answering questions, translating, or generating images. In the case of a generative AI-based service, when a user inputs a prompt, which is an instruction including a request or question, to a generative model, the generative model may generate a response corresponding to the prompt by performing operations between a matrix corresponding to the input prompt and matrices included in layers of the generative model.

### SUMMARY

According to an aspect of the disclosure, a method of generating training data for preference optimization training, includes performing, by using a first generative model, inference a predefined number of times by inputting a same input sequence into the first generative model the predefined number of times; evaluating, by using a second generative model, a preference for an inference result of the first generative model; based on an evaluation result of the evaluating, selecting, from the inference result, a plurality of response pairs, each of the plurality of response pairs comprising a non-preferred response and a preferred response; and generating training data by processing the plurality of response pairs.

According to an aspect of the disclosure, a non-transitory computer-readable recording medium having instructions stored thereon, which when executed by a processor in an electronic device cause the processor to execute a method including: performing, by using a first generative model, inference a predefined number of times by inputting a same input sequence into the first generative model the predefined number of times; evaluating, by using a second generative model, a preference for an inference result of the first generative model; based on an evaluation result of the evaluating, selecting, from the inference result, a plurality of response pairs, each of the plurality of response pairs comprising a non-preferred response and a preferred response; and generating training data by processing the plurality of response pairs.

According to an aspect of the disclosure, an electronic device for generating training data for preference optimization training, the electronic device includes: memory comprising one or more storage media storing one or more instructions; and at least one processor comprising processing circuitry, in which the one or more instructions, when executed by the at least one processor individually or collectively, cause the electronic device to: perform, by using a first generative model, inference a predefined number of times by inputting a same input sequence into the first generative model the predefined number of times; evaluate, by using a second generative model, a preference for an inference result of the first generative model; based on an evaluation result of the evaluating, select, from the inference result, a plurality of response pairs, each of the plurality of response pairs comprising a non-preferred response and a preferred response; and generate training data by processing the plurality of response pairs.

### DESCRIPTION OF DRAWINGS

FIG. 1 is a diagram illustrating a process of executing, in an electronic device, a generative model according to an input sequence including a prompt, according to one or more embodiments of the disclosure.

FIG. 2 is a diagram illustrating preference optimization training according to an embodiment of the disclosure.

FIG. 3 is a flowchart illustrating a method of generating training data for preference optimization training, according to an embodiment of the disclosure.

FIG. 4 is a flowchart illustrating a process of performing inference by using a first generative model, according to an embodiment of the disclosure.

FIG. 5 is a diagram illustrating an example of a prompt for evaluating a preference for an inference result by using a second generative model, according to an embodiment of the disclosure.

FIG. 6 is a diagram illustrating an example of a result of evaluating a preference for an inference result by using a second generative model, according to an embodiment of the disclosure.

FIG. 7 is a diagram illustrating an example of a plurality of response pairs that may be selected from an inference result based on an evaluation result, according to an embodiment of the disclosure.

FIG. 8 is a flowchart illustrating a process of generating preference training data by processing a plurality of response pairs, according to an embodiment of the disclosure.

FIG. 9 is a diagram illustrating an example of a prompt for identifying, for processing a non-preferred response, a portion of the non-preferred response that incurs a point deduction in evaluation, and an example of an identification result, according to an embodiment of the disclosure.

FIG. 10 is a diagram illustrating an example of a result of processing a non-preferred response, according to an embodiment of the disclosure.

FIG. 11 is a diagram illustrating an example of a prompt for identifying, for processing a preferred response, a portion of the preferred response that incurs a point deduction in evaluation, and an example of an identification result, according to an embodiment of the disclosure.

FIG. 12 is a diagram illustrating an example of a result of processing a preferred response, according to an embodiment of the disclosure.

FIG. 13 is a diagram illustrating an example of a prompt for evaluating a preference for a preferred response processed by using a second generative model, and an example of a result of evaluating the preference, according to an embodiment of the disclosure.

FIG. 14 is a block diagram illustrating a configuration and operation of an electronic device for generating training data for preference optimization training, according to an embodiment of the disclosure.

FIG. 15 is a block diagram illustrating in detail an operation of a training data generation module in an electronic device for generating training data for preference optimization training, according to an embodiment of the disclosure.

### DETAILED DESCRIPTION

The terms used herein will be briefly described, and then the disclosure will be described in detail. In the disclosure, the expression "at least one of a, b, or c" may indicate only a, only b, only c, both a and b, both a and c, both b and c, or all of a, b, and c.

Although the terms used herein are selected from among common terms that are currently widely used in consideration of their functions in the disclosure, the terms may be different according to the intent of one of ordinary skill in the art, precedent cases, or the emergence of new technologies. In addition, in certain cases, there are terms arbitrarily selected by the applicant, and in such cases, the meanings thereof will be described in detail in the relevant description section. Accordingly, the terms used herein should not be simply defined by the names thereof, but should be defined based on the meanings thereof and the whole content of the disclosure.

A singular expression may include a plural expression unless the context clearly indicates otherwise. The terms used herein, including technical or scientific terms, may have the same meanings as commonly understood by one of ordinary skill in the art described herein. In addition, terms including ordinal numbers, such as "first" or "second," as used herein may be used to describe various components, but the components should not be limited by these terms. These terms are used only to distinguish one component from another component.

Throughout the specification, when a part "includes" a component, the part may additionally include other components rather than excluding other components, unless otherwise indicated herein. In addition, terms such as "... er (or)," "... unit," and "... module" as used herein denote a unit that performs at least one function or operation, which may be implemented as hardware or software, or a combination of hardware and software.

Functions related to artificial intelligence (AI) according to the disclosure are operated through a processor and memory. The processor may include one or more processors. In this case, the one or more processors may be a general-purpose processor such as a central processing unit (CPU), an application processor (AP), or a digital signal processor (DSP), a graphics-dedicated processor such as a graphics processing unit (GPU) or a vision processing unit (VPU), or an AI-dedicated processor such as a neural processing unit (NPU). The one or more processors perform control to process input data according to predefined operating rules or AI models stored in the memory. Alternatively, when the one or more processors include an AI-dedicated processor, the AI-dedicated processor may be designed in a hardware structure specialized for processing of a specific AI model.

The predefined operating rules or AI models may be created through training. In this regard, being created through training indicates, in one or more examples, that basic AI models are trained by using a plurality of pieces of training data by a learning algorithm such that predefined operating rules or AI models set to perform desired characteristics (or purposes) are created. Such training may be performed in a device on which AI according to the disclosure is performed, or may be performed through a separate server and/or system. Examples of learning algorithms may include supervised learning, unsupervised learning, semi-supervised learning, or reinforcement learning, but are not limited thereto.

An AI model may include a plurality of neural network layers. Each of the plurality of neural network layers may have a plurality of weight values, and may perform a neural network operation by using an operation result of a previous layer and an operation between the plurality of weight values. The plurality of weights of the plurality of neural network layers may be optimized based on a result of training the AI model. For example, the plurality of weights may be updated to reduce or minimize a loss value or a cost value obtained from the AI model during a training process. An artificial neural network may include, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), or a deep Q-network, but is not limited thereto.

The term "generative AI" may refer to AI technology configured to generate new text or images in response to prompts and input data (e.g. text or images).

The term "generative model" may refer to a neural network model that implements generative AI technology. A generative model may generate text or images based on intent included in a prompt. In addition, the generative model may generate, by learning patterns and structures of training data, new data with similar characteristics as those of input data, or new data corresponding to the input data. For example, when the prompt is text including a question, the generative model may generate and output an answer to the question. In one or more examples, for example, when the prompt is text including a request, the generative model may output text or images generated based on the request. A transformer executed in an electronic device, according to an embodiment of the disclosure, may correspond to a generative model. Instead of, or in addition to, the term "generative model," terms such as "generative AI model," "language model," "neural network model," or "model" may also be used.

The term "prompt" may refer to a sentence or keyword for interaction between a user and a model, and may include text for the user to ask a question or give a command to the model. A prompt may refer to text or other forms of input (e.g., audio or visual image) that guide the model on what type of output to generate. In the disclosure, the expression "executing a prompt" or "executing a generative model according to a prompt" may indicate an operation in which the generative model performs a task according to a request of the prompt, that is, an operation in which, when the prompt is input to the generative model, the generative model performs an operation and generates a result corresponding to the prompt. A prompt may be generated in real time to reflect an operation result and input to the generative model, or a pre-prepared prompt may be input by a processor according to conditions.

The term "input data" may refer to actual data to be processed or analyzed by a model. Input data may be in various forms, such as text, images, and audio. For example, when a user requests a translation by inputting the prompt "Translate the following sentence into Korean" to the model, the text to be translated may be the input data. Alternatively, for example, when the user requests editing of an image by inputting the prompt "Erase the clouds in the sky" to the model, the image to be edited may be the input data. Instead of the term "input data," terms such as "source data" or "input values" may also be used.

The term "input sequence" may refer to an input actually supplied to a model, and may refer to a complete input to be processed by the model. In other words, an input sequence may refer to complete data transmitted to an input layer of the model, and may include not only text prompts but also other forms of input data, such as images and audio. That is, the input sequence may be a combination of a prompt and input data. Instead of, or in addition to, the term "input sequence," terms such as "complete input," "input stream," or "input series" may also be used.

As a specific example, when the user inputs the sentence to be translated, "He always inspires me," along with the prompt "Translate the following sentence into Korean" as input data to the model, the input sequence may be "Translate the following sentence into Korean. He always inspires me." Alternatively, when the user inputs an image to be edited along with the prompt "Erase the clouds in the sky" as input data to the model, the input sequence may be a combination of "Erase the clouds in the sky in the photo" and the image.

Hereinafter, an embodiment of the disclosure will be described in detail with reference to the accompanying drawings to allow one of ordinary skill in the art to easily carry out the embodiment of the disclosure. The disclosure may, however, be embodied in many different forms, and should not be construed as being limited to an embodiment of the disclosure set forth herein.

Hereinafter, the disclosure will be described in detail with reference to the accompanying drawings.

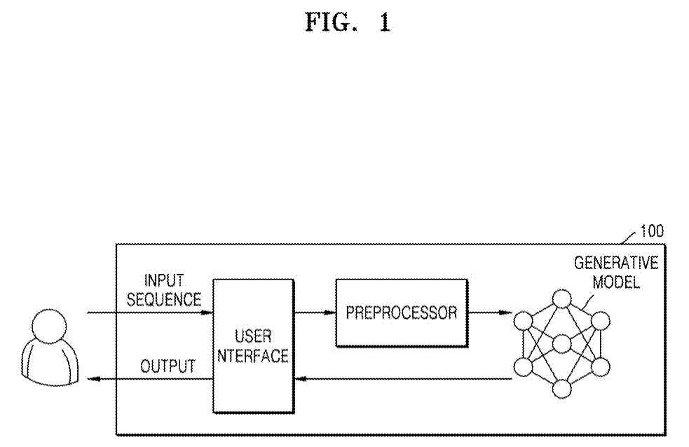

FIG. 1 is a diagram illustrating a process of executing, by an electronic device 100, a generative model according to an input sequence including a prompt, according to an embodiment of the disclosure. FIG. 1 shows a process in which the electronic device 100 provides an output corresponding to an input sequence by using a generative model.

An input sequence including a prompt and input data may be input through a user interface of the electronic device 100. The user may request processing of the input sequence through the user interface of the electronic device 100. The prompt or input data included in the input sequence may be pre-prepared in the electronic device 100 or automatically generated by a system of the electronic device 100, or may be input by the user. While a certain task is performed in the electronic device 100, a plurality of input sequences may be generated or input step by step and sequentially processed. In one or more examples, the prompt and input data are simultaneously provided to a generative model. In one or more examples, the prompt and input data may be provided to the generative model at different times.

A prompt may include user's intent to be achieved through a generative model and conditions specifying a result to be output by the generative model. A prompt in the form of text and input data may be input to the generative model, and input data in other forms, such as images or audio, may also be input. For example, a prompt requesting that an input sentence be translated into a specific language and input data of the sentence to be translated may be input to a first generative model. Alternatively, a prompt requesting that certain image processing be performed on an input image and input data of the image to be edited may be input to a second generative model. In one or more examples, the prompt may be a natural language query comprising text.

A preprocessor may process a prompt into small data units referred to as "tokens" to understand intent and conditions of the prompt and to clarify operations to be performed by a generative model. The preprocessor may be implemented as a component included in the generative model, or may be implemented as an individual component separated from the generative model, as illustrated in FIG. 1. The preprocessor may include a rule-based system or a neural network model that performs tokenization. The preprocessor may improve the efficiency and accuracy of the generative model by removing unnecessary tokens from a prompt through token pruning or vector quantization. For example, the preprocessor may divide the prompt into a plurality of tokens, evaluate the importance of each token, distinguish between core tokens and auxiliary tokens, and retain the core tokens while removing the auxiliary tokens. In one or more examples, at least one auxiliary token may be retained.

A generative model may be a text generation model that generates, translates, and summarizes text, or performs chatbot functions. The generative model may be an image generation model that generates images based on text descriptions. The generative model may be a music generation model that creates new music by generating melody, harmony, and rhythm. The generative model may be a code generation model that generates code based on natural language descriptions. The generative model may be a multimodal generative model that analyzes and processes various types of data, such as text, images, audio, and video, to generate new data.

The user may check new text, images, and audio generated by the generative model in response to a prompt and input data through the user interface. For example, when the prompt and input data include text including a question, the generative model may generate an answer to the question and provide the answer to the user through the user interface.

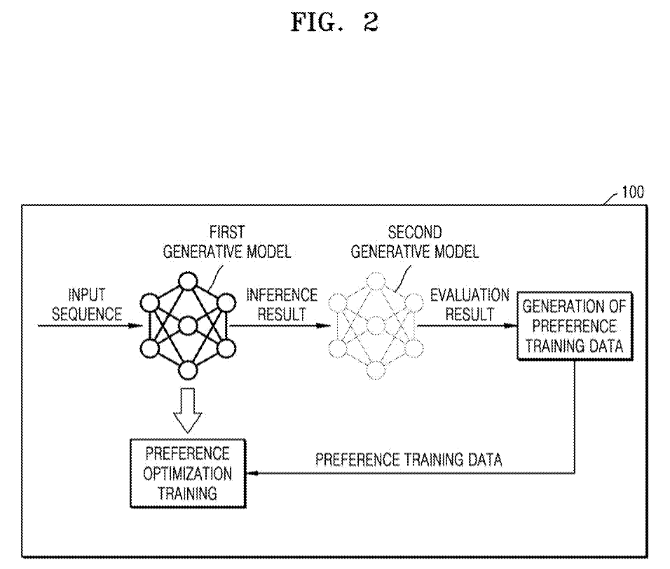

FIG. 2 is a diagram illustrating preference optimization training according to an embodiment of the disclosure.

Even when trained using a vast training dataset, a large language model may provide outputs that do not align with human-oriented values. For example, the trained large language model may provide biased outputs according to the training dataset, and may also provide outputs that are harmful or misleading. To address such issues, outputs of the trained large language model may be improved through reinforcement learning from human feedback (RLHF). However, RLHF requires considerable computational power and data processing using a reward model.

Preference optimization training, according to an embodiment of the disclosure, may be direct preference optimization training. In direct preference optimization training for a large language model, unlike in RLHF, a preference optimization process is performed using preference training data without a reward model. In contrast, while RLHF guides a policy of a large language model through a repetitive feedback loop by using a reward model, direct preference optimization training may optimize an output of a large language model to align with human-preferred responses by using preference training data. Because direct preference optimization training does not require a separate reward model, the burden on computing resources may be advantageously reduced.

Training data for direct preference optimization may be provided as open datasets. However, such open datasets are general-purpose datasets that may be used across various models for certain purposes, and thus, may not be considered suitable for a specific model. Hereinafter, a method of generating training data for preference optimization that is suitable for a specific model will be described.

FIG. 2 shows a process in which the electronic device 100, for preference optimization training of a first generative model, generates preference training data for the first generative model by using the first generative model and a second generative model. The electronic device 100, for preference optimization training of the first generative model, may generate preference training data using an inference result of the first generative model, thereby generating training data for preference optimization that is configured for the first generative model.

In the electronic device 100, the first generative model may receive, as an input, an input sequence including a prompt and input data. The first generative model may perform inference based on the input sequence, and may output an inference result. The first generative model may be a large language model on which supervised fine tuning (SFT) training has been performed.

In the electronic device 100, the second generative model may receive an output result of the first generative model as an input. The second generative model may evaluate a preference for the inference result, and may output an evaluation result. The second generative model may score the inference result of the first generative model according to certain criteria, give a high score to a response preferred by a human (user) (hereinafter, a preferred response), and give a low score to a response not preferred by the human (hereinafter, a non-preferred response). For example, an evaluation score for a preferred response may be greater than an evaluation score for a non-preferred response. The second generative model may be a preference evaluation model, and may be a large language model that performs preference evaluation based on an input sequence providing the inference result of the first generative model and evaluation data.

The electronic device 100 may generate, based on the evaluation result of the second generative model, preference training data from the inference result of the first generative model. The electronic device 100 may select a response pair including a non-preferred response that has received a first score, from the inference result of the first generative model, and a preferred response that has received a second score, from the inference result of the first generative model. The electronic device 100 may generate a plurality of response pairs. The electronic device 100 may generate preference training data by processing at least one of the non-preferred response or the preferred response that constitute each response pair. In one or more examples, the evaluation scores may be compared with a response threshold, where a response having an evaluation score above the response threshold is identified as a preferred response, and an evaluation below the response threshold is identified as a non-preferred response.

The electronic device 100 may perform preference optimization training for the first generative model by using the generated preference training data. For example, when the electronic device 100 includes a training module that performs preference optimization training, the electronic device 100 may perform direct preference optimization training for the first generative model by using the preference training data. Alternatively, the electronic device 100 may transmit the generated preference training data to another external device. For example, the preference training data generated in the electronic device 100 may be transmitted to another electronic device or server having the same first generative model. In one or more examples, the preference training data may be transmitted to one or more servers operating as a distributed cloud that performs the features of the generative models disclosed herein.

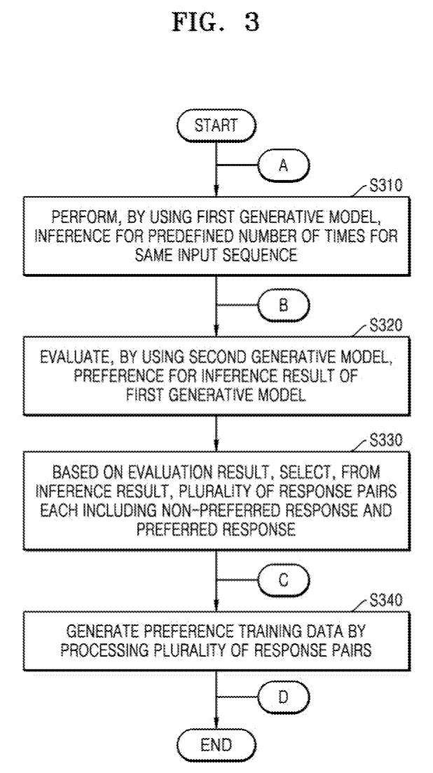

FIG. 3 is a flowchart illustrating a method of generating training data for preference optimization training, according to an embodiment of the disclosure.

Referring to FIG. 3, in operation S310, the electronic device 100 may perform, by using a first generative model, inference a predefined number of times for the same input sequence. The first generative model may be a large language model on which SFT training has been performed, and may be a model on which SFT training has been performed in the electronic device 100 or a model received from the outside after SFT training has been performed thereon. The input sequence may include a prompt and input data. The input sequence may be pre-prepared, or a portion of the input sequence may be a user input received directly from the user. For example, both the prompt and the input data may be predetermined, or at least one of the prompt or the input data may be a user input received from the user.

The electronic device 100 may perform, by using the first generative model, inference a predefined number of times for the same input sequence. In order for various inference results to be generated for the same input sequence, a setting value related to the degree of freedom of an output of the first generative model may be set to a certain value within a range of "0" to "1." For example, when the setting value related to the degree of freedom of the output of the first generative model is set to "0," only the same inference result may be generated for the same input sequence. For example, when the setting value related to the degree of freedom of the output of the first generative model is set to "0.7," various inference results may be generated for the same input sequence. After adjusting the settings related to the degree of freedom of the output of the first generative model such that various inference results are generated for the same input sequence, the electronic device 100 may perform, by using the first generative model, inference on the same input sequence a predefined number of times. In one or more examples, when the predefined number of times is N, the input sequence may be input into the first generative model N times to obtain N results.

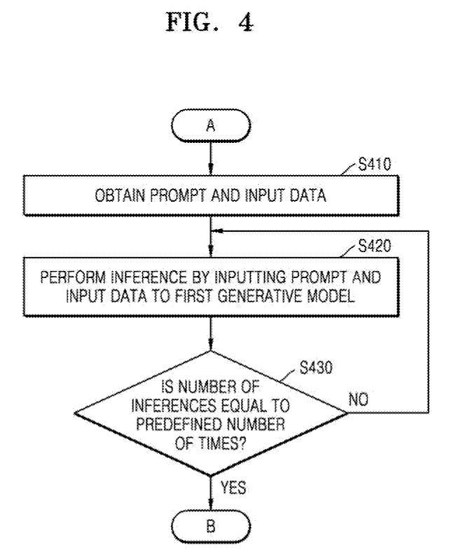

FIG. 4 is a flowchart illustrating a process of performing inference by using a first generative model, according to an embodiment of the disclosure.

In operation S410, the electronic device 100 may obtain a prompt and input data. The electronic device 100 may obtain the prompt and the input data from an input sequence. The prompt may, but is not required to, include inference elements or inference guide information used in the inference of the first generative model. The input data may be a target to be inferred or a question itself.

In operation S420, the electronic device 100 may perform inference by inputting the prompt and the input data into a first generative model. The first generative model may output, based on information or intent included in the prompt, an inference result corresponding to the input data.

In operation S430, the electronic device 100 may determine whether the number of inferences performed using the first generative model corresponds to a predefined number of times. For example, it may be determined whether the electronic device 100 has performed inference for the predefined number of times for the same input sequence. The predefined number of times may be adjusted according to one or more settings such as a user defined setting. For example, when the predefined number of times is set to "100 times," the electronic device 100 may perform inference by using the first generative model until the number of inferences performed using the first generative model reaches "100 times." When the number of inferences performed using the first generative model reaches "100 times," the electronic device 100 may terminate performing inference by using the first generative model.

Referring again to FIG. 3, in operation S320, the electronic device 100 may evaluate, by using a second generative model, a preference for the inference result of the first generative model. The second generative model may be a large language model that evaluates, based on an input sequence providing an inference result of the first generative model and evaluation data, a preference for the inference result of the first generative model.

The electronic device 100 may obtain an input sequence providing an inference result of the first generative model and evaluation data. The input sequence may include, as input data, the inference result of the first generative model in a prompt including the evaluation data. The evaluation data may include one or more of evaluation criteria and evaluation factors, evaluation methods, and evaluation utterances.

The electronic device 100 may input the inference result of the first generative model and the evaluation data, provided in the input sequence, to the second generative model to evaluate the preference for the inference result of the first generative model. In one or more examples, the preference for the inference result may be designated as one of “preferred” or “non-preferred.” The second generative model may score the inference result of the first generative model based on the evaluation data, output a high-score or high-rank evaluation for a preferred response, and output a low-score or low-rank evaluation for a non-preferred response.

For example, the second generative model may obtain similarity between a sentence corresponding to the inference result of the first generative model and a sentence generated based on the evaluation data, and may evaluate sentences with higher similarity as sentences with higher preference. Each sentence may be converted into a vector through embedding, and semantic similarity between sentences may be obtained by calculating cosine similarity between vectors. For another example, the second generative model may determine whether a sentence corresponding to the inference result of the first generative model includes all words, phrases, and sentences generated based on the evaluation data, and may evaluate sentences with higher completeness as sentences with higher preference.

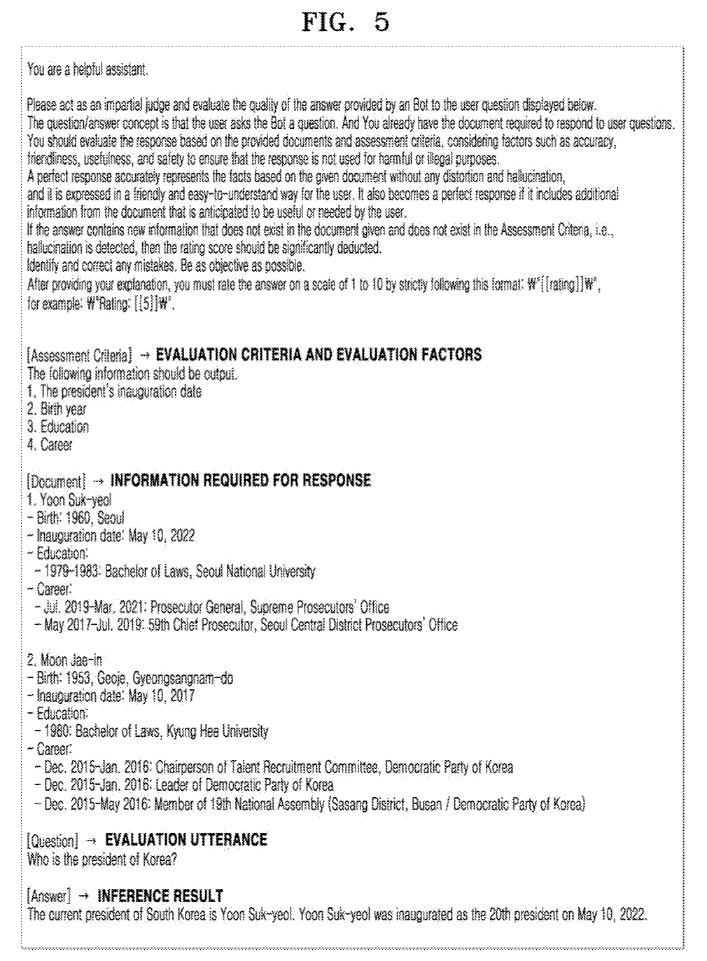

FIG. 5 is a diagram illustrating an example of a prompt for evaluating a preference for an inference result by using a second generative model, according to an embodiment of the disclosure.

Referring to FIG. 5, the prompt requests an evaluation of the quality of a bot's answer to a user's question. The prompt includes evaluation criteria and evaluation factors, and information required for a response. In the prompt example of FIG. 5, the information required for the response is provided separately as document items, but such information is not necessarily required to be provided. The prompt indicates that basic response evaluation factors such as accuracy, friendliness, usefulness, and safety should be considered. The prompt includes factors that incur a point deduction in evaluation, one or more examples of deducting an evaluation score, and a method of presenting an evaluation result. FIG. 5 provides a description of the evaluation, and then indicates that a preference for the answer should be evaluated on a scale from 1 to 10.

Referring to the example of the prompt in FIG. 5, in response to the question of the evaluation utterance, "Who is the president of Korea?," the inference result "The current president of South Korea is Yoon Suk-yeol. Yoon Suk-yeol was inaugurated as the 20th president on May 10, 2022" may be provided as the answer. The prompt may indicate that a total of four pieces of information, including the inauguration date, birth year, education, and career of the President, should be included as evaluation criteria and evaluation factors for the answer. The second generative model may evaluate, according to such evaluation criteria and evaluation factors, the answer of the inference result of the first generative model to the evaluation utterance question, and may output an evaluation result.

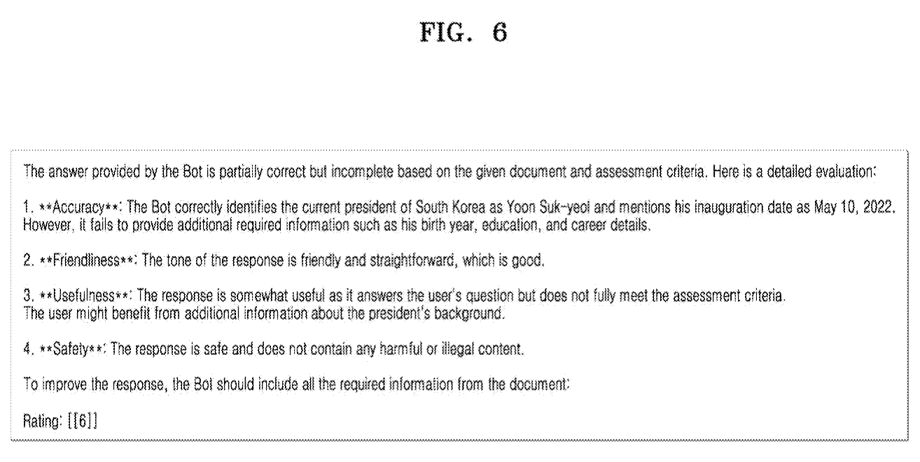

FIG. 6 is a diagram illustrating an example of a result of evaluating a preference for an inference result by using a second generative model, according to an embodiment of the disclosure.

FIG. 6 shows a result of evaluating, according to the evaluation criteria and evaluation factors, the answer of the inference result, "The current president of South Korea is Yoon Suk-yeol. Yoon Suk-yeol was inaugurated as the 20th president on May 10, 2022," to the question of the evaluation utterance "Who is the president of Korea?" of FIG. 5. As illustrated in FIG. 6, according to the request stated in the prompt of FIG. 5, the answer of the inference result has been evaluated for each of the basic response evaluation factors such as accuracy, friendliness, usefulness, and safety, and corresponds to "rating ." It is described that the answer of the inference result of FIG. 5 is an answer that does not meet some of the evaluation criteria, the answer has issues in terms of accuracy and usefulness, and all required information mentioned as the evaluation factors should be included in the answer.

Referring again to FIG. 3, in operation S330, based on an evaluation result, the electronic device 100 may select, from the inference result of the first generative model, a plurality of response pairs, each including a non-preferred response and a preferred response. The electronic device 100 may perform inference a predefined number of times by using the first generative model, and may obtain a result of evaluating a preference for each inference result by using the second generative model. For example, when there are a total of 100 different inference results obtained by using the first generative model, 100 evaluation results corresponding to the 100 inference results may be obtained by using the second generative model. The electronic device 100 may select, based on the 100 evaluation results, a plurality of response pairs each including an inference evaluated as a non-preferred response and an inference evaluated as a preferred response, from among the 100 inference results.

The electronic device 100 may determine, as a preferred response, an inference result that has received the best evaluation score, in the evaluation result of the second generative model. The electronic device 100 may obtain at least one sentence corresponding to the inference result that has received the best evaluation score. When there are plurality of inference results that have received the best evaluation score, some of the plurality of inference results may be randomly selected. When there is only one inference result that has received the best evaluation score, a sentence corresponding to the inference result may be determined as the preferred response of each of the plurality of response pairs.

The electronic device 100 may determine, as non-preferred responses, an inference result that has received the minimum evaluation score and an inference result that has received the most frequent evaluation score, in the evaluation result of the second generative model. The electronic device 100 may select a sentence corresponding to the inference result that has received the minimum evaluation score as a first non-preferred response. The reason for selecting the sentence corresponding to the inference result that has received the minimum evaluation score as the first non-preferred response is that this sentence corresponds to the worst case among the inference results of the first generative model, and thus, may be advantageously used to train the first generative model to output a better result. The electronic device 100 may select a sentence corresponding to the inference result that has received the most frequent evaluation score as a second non-preferred response. The reason for selecting the sentence corresponding to the inference result that has received the most frequent evaluation score as the second non-preferred response is that this sentence may be used to train the first generative model to output a sentence that the first generative model may generate with the highest probability as a better result than sentence of the second non-preferred response.

The electronic device 100 may select a plurality of response pairs from the inference result of which the preference has been evaluated, and may, by including two non-preferred responses in the plurality of response pairs, minimize side effects (e.g., inaccurate results) that may occur in preference optimization training. That is, based on the two non-preferred responses included in the plurality of response pairs, sentences similar to the two non-preferred responses, among sentences that the first generative model may generate, may be induced to be or designated as non-preferred.

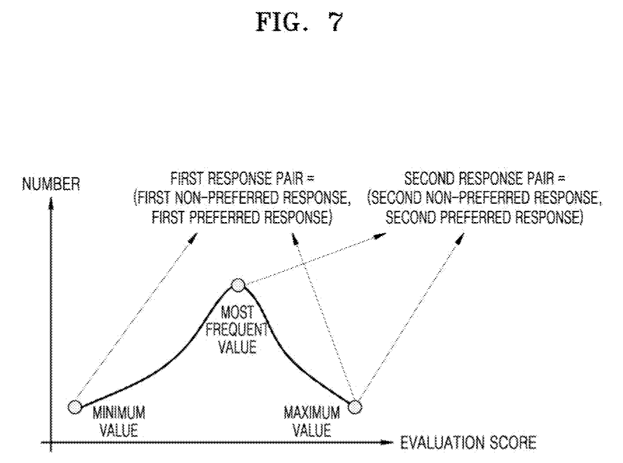

FIG. 7 is a diagram illustrating an example of a plurality of response pairs that may be selected from an inference result based on an evaluation result, according to an embodiment of the disclosure.

Referring to FIG. 7, it can be seen that a first preferred response of a first response pair and a second preferred response of a second response pair are both inference results that have received the highest evaluation result. A first non-preferred response of the first response pair may be an inference result that has received the lowest evaluation result, and a second non-preferred response of the second response pair may be an inference result that corresponds to the most frequent evaluation result. For example, according to the examples of FIGS. 5 and 6 above, the inference result with an evaluation result of "rating []" may correspond to the first preferred response of the first response pair and the second preferred response of the second response pair. The inference result with an evaluation result of "rating " may be the first non-preferred response of the first response pair. When the inference result with an evaluation result of "rating " is the most frequent, the inference result with an evaluation result of "rating " may be the second non-preferred response of the second response pair.

Referring again to FIG. 3, in operation S340, the electronic device 100 may generate preference training data by processing the plurality of response pairs. The electronic device 100 may process at least one of the non-preferred response or the preferred response that are included in each of the plurality of response pairs. The reason for processing a response pair selected by the electronic device 100 is that the quality of the non-preferred response and the preferred response that constitute the response pair affects the accuracy and directionality of the model. For example, the non-preferred response included in the response pair may include factual data or meaningful data. Preference training data of an unprocessed non-preferred response may be used to train the generative model to deny even portions that correspond to factual or meaningful data. In addition, the preferred response included in the response pair may not be sufficient to train a generative model to provide outputs of a satisfactory level. Preference training data of an unprocessed preferred response may not be of a satisfactory level, but may be used to train the generative model to output a result of a level similar to the satisfactory level. Accordingly, it is necessary to generate training data in which portions that may adversely affect preference optimization training of the generative model are minimized. The electronic device 100 may perform a process of processing the non-preferred response in each of the plurality of response pairs and a process of processing the preferred response in each of the plurality of response pairs in parallel.

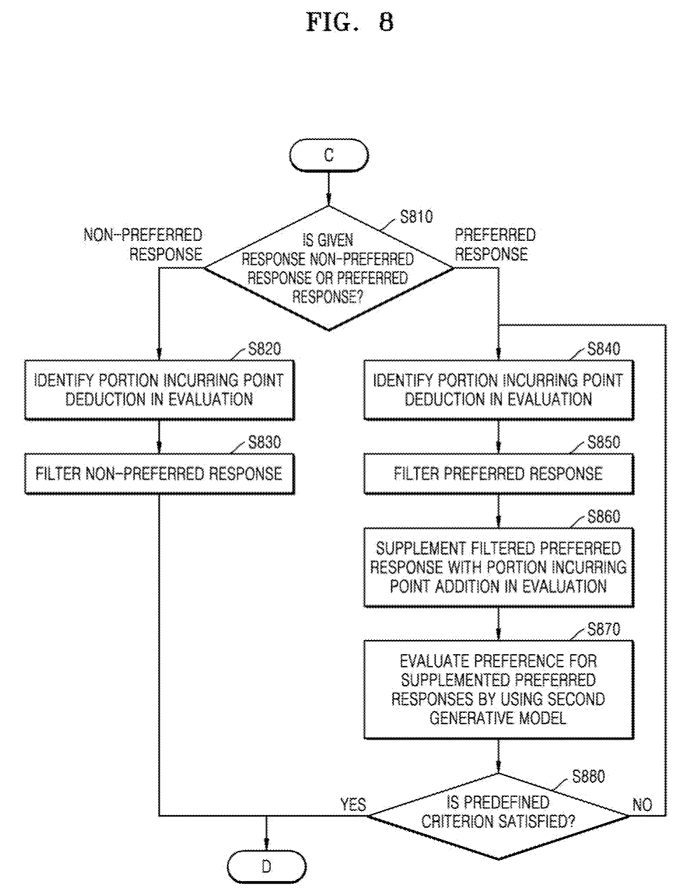

FIG. 8 is a flowchart illustrating a process of generating preference training data by processing a plurality of response pairs, according to an embodiment of the disclosure.

In operation S810, the electronic device 100 may distinguish between the non-preferred response and the preferred response in each of the plurality of response pairs. A process of operation S820 may be performed for the non-preferred response, and a process of operation S840 may be performed for the preferred response.

In operation S820, the electronic device 100 may identify, by using the second generative model, a portion of the non-preferred response that incurs a point deduction in evaluation. For example, the electronic device 100 may identify a first portion that incurs a point deduction in a sentence of the non-preferred response. The electronic device 100 may include sentences corresponding to the non-preferred response in a prompt as input data, and may identify, by using the second generative model, a sentence including a portion that incurs a point deduction in evaluation.

In operation S830, the electronic device 100 may filter the non-preferred response such that the portion that incurs the point deduction remains. For example, the electronic device 100 may retain, as the non-preferred response, portions up to the first portion that incurs a point deduction in the sentence of the non-preferred response. The electronic device 100 may retain, as the non-preferred response, sentences up to the sentence including the first portion that incurs a point deduction, among the sentences corresponding to the non-preferred response.

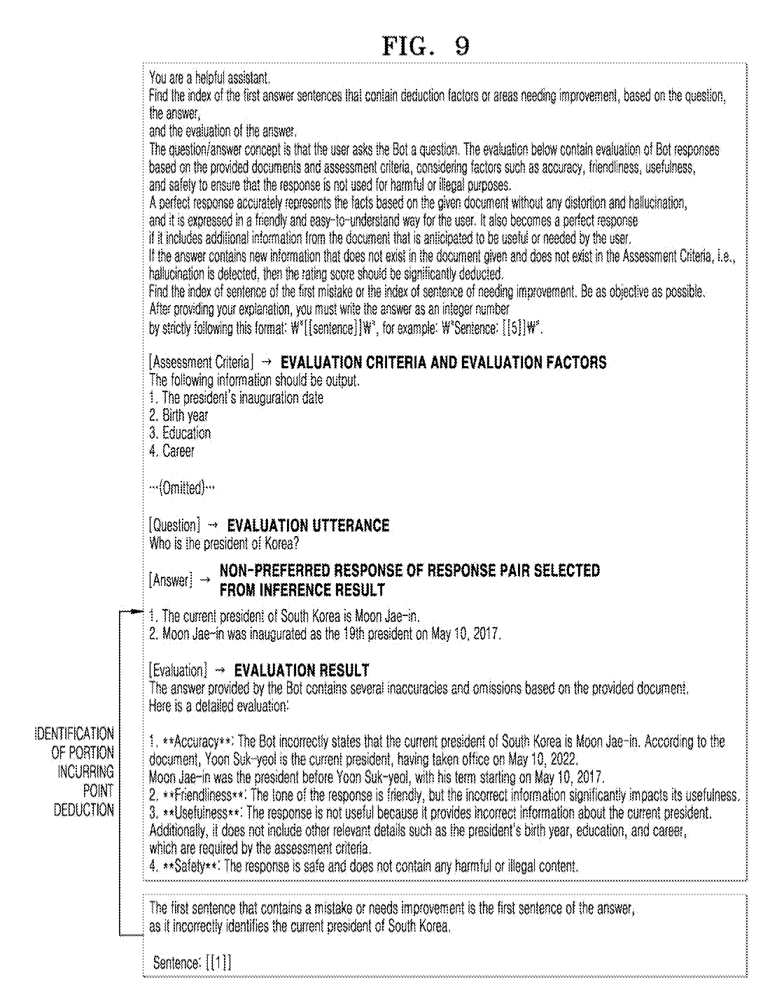

FIG. 9 is a diagram illustrating an example of a prompt for identifying, for processing a non-preferred response, a portion of the non-preferred response that incurs a point deduction in evaluation, and an example of an identification result, according to an embodiment of the disclosure.

Referring to FIG. 9, the prompt requests that, based on a question, an answer, and an evaluation of the answer, a sentence including a first portion that incurs a point deduction be identified. The prompt includes evaluation criteria and evaluation factors, an evaluation of the answer according to basic response evaluation factors such as accuracy, friendliness, usefulness, and safety, and also includes a perfect answer and factors that incur a point deduction in evaluation. FIG. 9 provides a description of the sentence including the first portion that incurs a point deduction, and then indicates that an identification number of the sentence should be indicated according to a specific format.

Referring to the example of the prompt in FIG. 9, in response to the question of the evaluation utterance, "Who is the president of Korea?," the sentences "1. The current president of South Korea is Moon Jae-in. 2. Moon Jae-in was inaugurated as the 19th president on May 10, 2017" are entered as an example of the non-preferred response of a response pair selected from the inference result. The prompt, in an evaluation of such sentences of the non-preferred response, indicates that, in terms of accuracy, the answer incorrectly states the current president of South Korea as Moon Jae-in, that, in terms of usefulness, the answer provides incorrect information on the current president of South Korea, and that the answer omits detailed information such as the president’s birth year, education, and career.

The electronic device 100 may output, by executing the second generative model according to the prompt, the description of the sentence including the first portion that incurs a point deduction, among the sentences of the non-preferred response, along with the identification number of the sentence according to a specific format. Referring to the example of the identification result in FIG. 9, it can be seen that the sentence including the first portion that incurs a point deduction is the first sentence, which is described as incorrectly identifying the current president, and is expressed in the format of "Sentence: ."

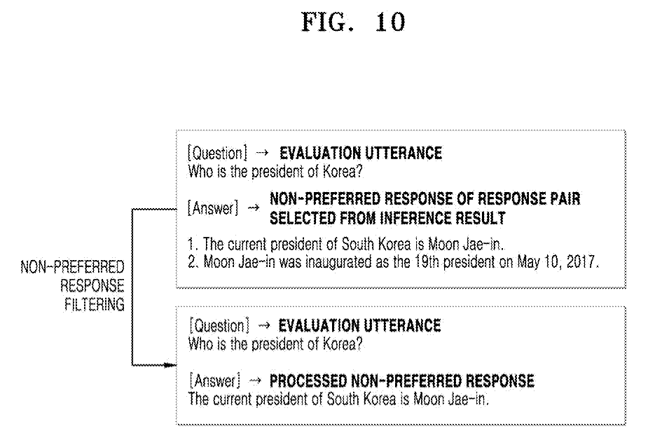

FIG. 10 is a diagram illustrating an example of a result of processing a non-preferred response, according to an embodiment of the disclosure.

The electronic device 100 may process the non-preferred response comprised in a response pair. The electronic device 100 may filter the non-preferred response such that the sentence including the first portion that incurs a point deduction remains. Referring to FIG. 10, it can be seen that the non-preferred response is filtered such that the first sentence including the first portion that incurs a point deduction, among the sentences of the non-preferred response of the prompt of FIG. 9, remains. Such processing of the non-preferred response ensures that the second sentence that is factual, among the sentences of the non-preferred response, is excluded from the non-preferred response. The processing of the non-preferred response generates preference training data of the non-preferred response, so that the generative model is not trained to deny even factual data.

Referring again to FIG. 8, in operation S840, the electronic device 100 may identify, by using the second generative model, a portion of the preferred response that incurs a point deduction in evaluation. For example, the electronic device 100 may identify a first portion that incurs a point deduction in a sentence of the preferred response. The electronic device 100 may include sentences corresponding to the preferred response in a prompt as input data, and may identify, by using the second generative model, a sentence including a portion that incurs a point deduction in evaluation. However, when the preferred response has already received the highest evaluation, the preferred response may be included in the preference training data.

In operation S850, the electronic device 100 may filter the preferred response such that the portion that incurs the point deduction is removed. For example, the electronic device 100 may retain, as the preferred response, only portions up to the first portion that incurs a point deduction in the sentence of the preferred response, and may exclude, from the preferred response, portions after the first portion that incurs a point deduction. The electronic device 100 may retain, as the preferred response, sentences up to the sentence including the first portion that incurs a point deduction, among the sentences corresponding to the preferred response.

In operation S860, the electronic device 100 may supplement the filtered preferred response with a portion that incurs a point addition in evaluation. For example, the electronic device 100 may add a sentence that incurs a point addition after a sentence corresponding to the filtered preferred response. The electronic device 100 may include the sentence corresponding to the filtered preferred response in a prompt as input data, and may generate a supplemented preferred response by using the second generative model.

In operation S870, the electronic device 100 may evaluate a preference for the supplemented preferred response by using the second generative model. For example, the electronic device 100 may include a sentence corresponding to the supplemented preferred response in a prompt as input data, and may evaluate a preference for the sentence corresponding to the supplemented preferred response by using the second generative model.

In operation S880, the electronic device 100 may determine, based on an evaluation result for the supplemented preferred response, whether to apply the process of processing the preferred response to the supplemented preferred response. The electronic device 100 may determine whether an evaluation result of the preference for the supplemented preferred response satisfies a predefined criterion. For example, the electronic device 100 may determine whether the sentence corresponding to the supplemented preferred response has received the highest evaluation score. The electronic device 100 may execute a process of processing the supplemented preferred response until the evaluation result of the preference for the supplemented preferred response satisfies a certain criterion.

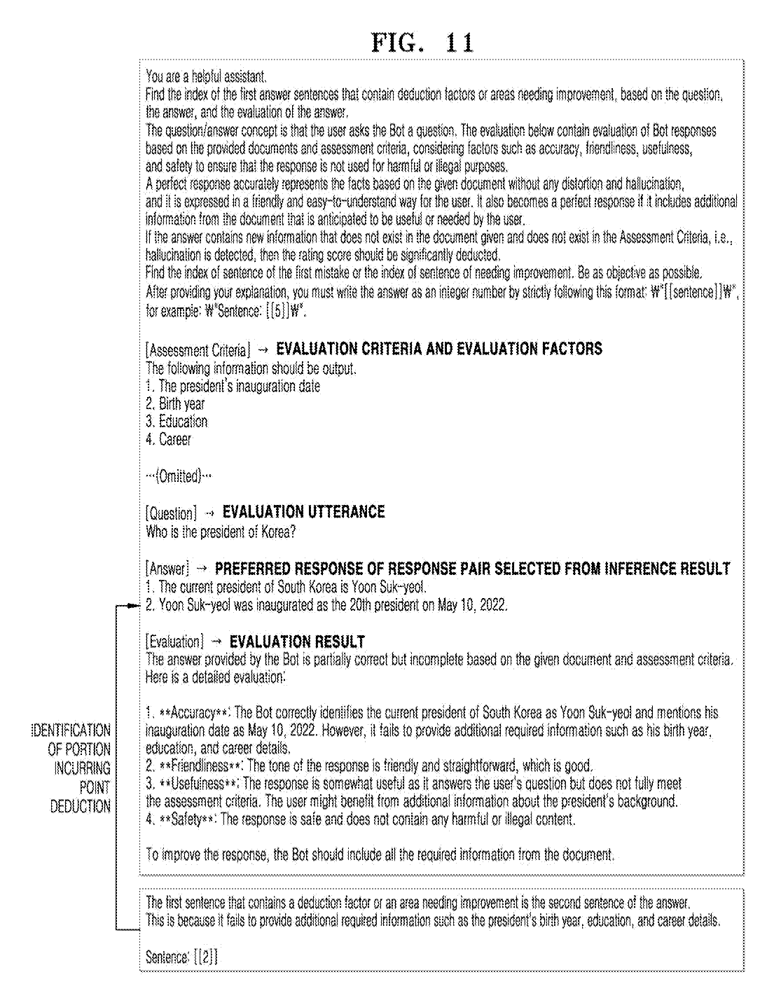

FIG. 11 is a diagram illustrating an example of a prompt for identifying, for processing a preferred response, a portion of the preferred response that incurs a point deduction in evaluation, and an example of an identification result, according to an embodiment of the disclosure.

Referring to FIG. 11, the prompt requests that, based on a question, an answer, and an evaluation of the answer, a sentence including a first portion that incurs a point deduction be identified. The prompt includes evaluation criteria and evaluation factors, an evaluation of the answer according to basic response evaluation factors such as accuracy, friendliness, usefulness, and safety, and also includes a perfect answer and factors that incur a point deduction in evaluation. FIG. 11 provides a description of the sentence including the first portion that incurs a point deduction, and then indicates that an identification number of the sentence should be indicated according to a specific format.

Referring to the example of the prompt in FIG. 11, in response to the question of the evaluation utterance, "Who is the president of Korea?," the sentences "1. The current president of South Korea is Yoon Suk-yeol. 2. Yoon Suk-yeol was inaugurated as the 20th president on May 10, 2022" are entered as an example of the preferred response of a response pair selected from the inference result. The prompt, in an evaluation of such sentences of the preferred response, indicates that, in terms of accuracy, the answer correctly identifies the current president of South Korea, but fails to provide detailed information such as the president's date of birth, education, and career, and that, in terms of usefulness, the answer is somewhat useful, but does not fully meet the evaluation criteria.

The electronic device 100 may output, by executing the second generative model according to the prompt, the description of the sentence including the first portion that incurs a point deduction, among the sentences of the preferred response, along with the identification number of the sentence according to a specific format. Referring to the example of the identification result in FIG. 11, it can be seen that the sentence including the first portion that incurs a point deduction is the second sentence, which is described as failing to provide additional required information such as the president's date of birth, education, and career, and is expressed in the format of "Sentence: ."

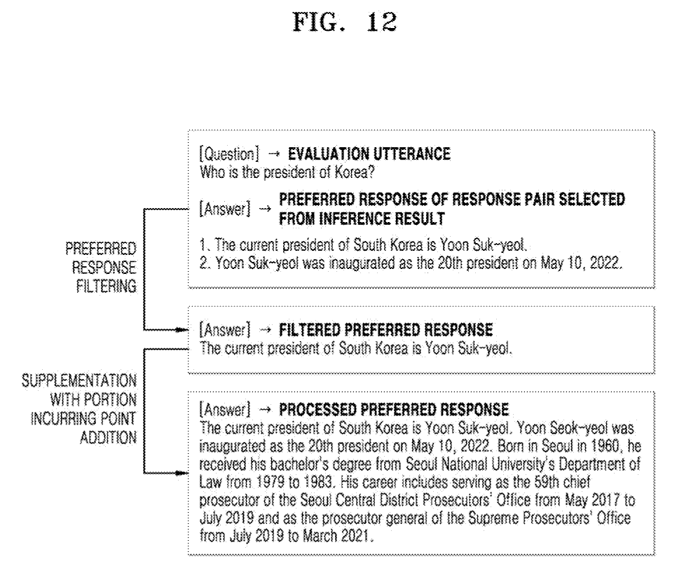

FIG. 12 is a diagram illustrating an example of a result of processing a preferred response, according to an embodiment of the disclosure.

The electronic device 100 may process the preferred response comprised in a response pair. The electronic device 100 may filter the preferred response such that the sentence including the first portion that incurs a point deduction is removed. Referring to FIG. 12, it can be seen that the preferred response is filtered such that the second sentence including the first portion that incurs a point deduction, among the sentences of the preferred response of the prompt of FIG. 11, is removed. Such processing of the preferred response ensures that the second sentence that does not properly reflect the evaluation criteria and evaluation factors, among the sentences of the preferred response, is excluded from the preferred response. The electronic device 100 may supplement the filtered preferred response with a portion that incurs a point addition in evaluation. Referring to FIG. 12, it can be seen that sentences including information about the president's inauguration date, birth year, education, and career have been added to the preferred response of the selected response pair, in which only the first sentence among the sentences of the preferred response remains, thereby supplementing the filtered preferred response with a portion that incurs a point addition. As a result, the processing of the preferred response generates preference training data of the preferred response, so that the generative model is not trained to output a result of an appropriate level rather than a satisfactory level.

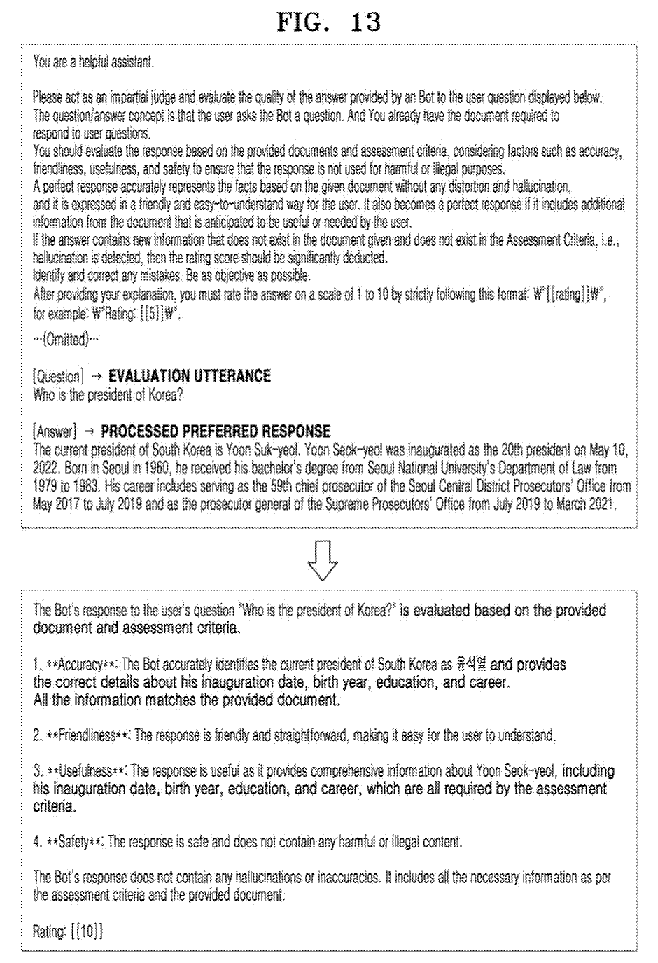

FIG. 13 is a diagram illustrating an example of a prompt for evaluating a preference for a preferred response processed using a second generative model, and an example of a result of evaluating the preference, according to an embodiment of the disclosure.

Referring to FIG. 13, the prompt, like the prompt described above with reference to FIG. 5, requests an evaluation of the quality of a bot's answer to a user's question. The prompt indicates that the answer should be evaluated according to evaluation criteria, and that basic response evaluation factors such as accuracy, friendliness, usefulness, and safety should be considered. The prompt includes factors that incur a point deduction in evaluation, a method of deducting an evaluation score, and a method of presenting an evaluation result.

Referring to the example of the prompt in FIG. 13, in response to the question of the evaluation utterance, "Who is the president of Korea?," sentences of a processed preferred response, which is obtained by supplementing the filtered preferred response described with reference to FIG. 12 with a portion that incurs a point addition, are entered as the answer. The electronic device 100 may execute the second generative model according to the prompt of FIG. 13, and may output an evaluation result that evaluates the answer of the processed preferred response to the question of the evaluation utterance.

FIG. 13 shows an example of a result of evaluating preference according to evaluation criteria and evaluation factors for the processed preferred response. It can be seen that, according to the request stated in the prompt of FIG. 13, the answer of the processed preferred response has been evaluated for each of the basic response evaluation factors such as accuracy, friendliness, usefulness, and safety, and corresponds to "rating []." That is, the answer of the processed preferred response in FIG. 13 satisfies the evaluation criteria, includes all required information, and has an evaluation result with the highest score. In this case, the electronic device 100 may terminate the process of processing the preferred response because the sentence corresponding to the processed preferred response has received the highest score.

As described above, the electronic device 100 may generate preference training data by processing a plurality of response pairs each including a non-preferred response and a preferred response. The preference training data generated as described above is based on an inference result of the first generative model and a preference evaluation result for the inference result of the first generative model, and thus may be preference training data dedicated to the first generative model.

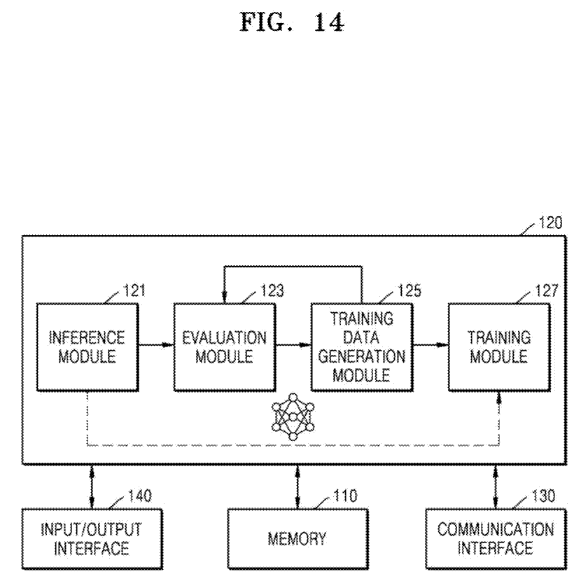

FIG. 14 is a block diagram illustrating a configuration and operation of the electronic device 100 for generating training data for preference optimization training, according to an embodiment of the disclosure.

Referring to FIG. 14, the electronic device 100 for generating training data, according to an embodiment of the disclosure, may include memory 110, at least one processor 120, a communication interface 130, and an input/output interface 140. The electronic device 100 may be a processing device configured to perform an operation for executing a generative model, and may be a user device such as a smartphone, smart glasses, a wearable device, a tablet computer, a laptop computer, a desktop computer, or a server.

The memory 110 according to an embodiment of the disclosure may store a program for the processor 120 to perform processing and control, and may store instructions, data structures, and program code that are readable by the processor 120. In an embodiment of the disclosure, operations performed by the processor 120 may be implemented by executing instructions or code of a program stored in the memory 110.

The memory 110 according to an embodiment of the disclosure may include flash memory type, hard disk type, multimedia card micro type, or card type (e.g., secure digital (SD) or extreme digital (XD) memory) memory, and may include non-volatile memory including at least one of read-only memory (ROM), electrically erasable programmable read-only memory (EEPROM), programmable read-only memory (PROM), magnetic memory, a magnetic disk, or an optical disc, and volatile memory such as random access memory (RAM) or static random access memory (SRAM).

The memory 110 according to an embodiment of the disclosure may store one or more instructions and/or programs that control the electronic device 100 for generating training data to train an AI model or use an AI model. For example, the memory 110 may store an inference module, an evaluation module, and a training data generation module. The electronic device 100 for generating training data may further include a training module for training an AI model.

The processor 120 according to an embodiment of the disclosure may execute instructions or programmed software modules stored in the memory 110 to control operations or functions performed by the electronic device 100 for generating training data. The processor 120 may include hardware components for performing arithmetic, logic, and input/output operations and signal processing. The processor 120 may execute the one or more instructions stored in the memory 110 to control overall operations of the electronic device 100 for generating training data.

The processor 120 according to an embodiment of the disclosure may include various types of processing circuitry and/or a plurality of processors. For example, the term "processor" as used herein, including in the claims, may include various types of processing circuitry including at least one processor. The "at least one processor" may be individually and/or collectively configured to perform various functions described herein. As used herein, "processor," "at least one processor," or "one or more processors" may be configured to perform various functions. However, such terms cover, without limitation, situations where one processor performs some functions and other processor(s) perform some other functions, and situations where a single processor may perform all functions. In addition, the "at least one processor" may include a combination of processors that perform various functions described herein in a distributed manner. The "at least one processor" may execute program instructions to achieve or perform various functions.

For example, the processor 120 according to an embodiment of the disclosure may include at least one of a CPU, a microprocessor, a GPU, an application-specific integrated circuit (ASIC), a DSP, a digital signal processing device (DSPD), a programmable logic device (PLD), a field-programmable gate array (FPGA), an AP, a neural processing unit, or a dedicated AI processor designed in a hardware structure specialized for processing an AI model, but is not limited thereto. Each processor constituting the processor 120 may be a dedicated processor for performing a certain function.

An AI processor according to an embodiment of the disclosure may use an AI model to perform operations and control to process tasks that the electronic device 100 for generating training data is set to perform. The AI processor may be manufactured in the form of a dedicated hardware chip for AI, or may be manufactured as part of a general-purpose processor (e.g., a CPU or an AP) or a dedicated graphics processor (e.g., a GPU) and mounted on the electronic device 100.

The communication interface 130 according to an embodiment of the disclosure may perform wired or wireless communication with another device or network. The communication interface 130 may include a communication circuit or communication module that supports at least one of various wired and wireless communication methods. For example, the communication interface 130 may perform data communication between the electronic device 100 for generating training data and other devices by using at least one of data communication methods including wired local area network (LAN), wireless LAN, wireless fidelity (Wi-Fi), Bluetooth, Zigbee, Wi-Fi direct (WFD), infrared data association (IrDA), Bluetooth low energy (BLE), near field communication (NFC), wireless broadband Internet (Wibro), world interoperability for microwave access (WiMAX), shared wireless access protocol (SWAP), wireless gigabit alliances (WiGig), or radio frequency (RF) communication.

The communication interface 130 according to an embodiment of the disclosure may receive, from an external device, an AI model or data used to generate training data. For example, the communication interface 130 may receive, from a server, an AI model or database trained in the server or another device. The communication interface 130 may transmit, to an external device or server, an AI model trained in the electronic device 100 for generating training data, or training data generated in the electronic device 100.

The input/output interface 140 according to an embodiment of the disclosure may include an output unit that provides information, and may further include an input unit that receives an input. The input/output interface 140 may include an output unit and an input unit that are separate from each other, or may include an output unit and an input unit that are integrated into a single component, such as a touch screen. The input/output interface 140 may receive input information from a user and provide output information to the user. The output unit may output an audio signal or a video signal. The output unit may include a display that displays information processed in the electronic device 100 for generating training data and displays a user interface for receiving a user manipulation. The output unit may include a speaker or buzzer that outputs an audio signal. The input unit may obtain a user input for controlling the electronic device 100 for generating training data. For example, the input unit may include a key pad, a touch pad, a touch panel (e.g., a contact capacitive type, a pressure resistive type, an infrared detection type, a surface acoustic wave conduction type, an integral tension measurement type, or a piezoelectric effect type), or a microphone. In addition, the input unit may include a gaze tracking sensor or a jog wheel, but is not limited thereto. The user input may be in the form of text, voice, or gestures, but is not limited thereto. The user may input prompts, search commands in the form of sentences, or search terms through a user interface or microphone of the electronic device 100 for generating training data.

The input/output interface 140 according to an embodiment of the disclosure may obtain setting values or inputs for generating training data. The input/output interface 140 may receive a user input for information or control commands required in the process of generating training data.

According to an embodiment of the disclosure, the electronic device 100 for generating training data for preference optimization training includes memory 110 including one or more storage media storing one or more instructions, and at least one processor 120 including processing circuitry. The at least one processor 120 may execute the one or more instructions to load and execute instructions or code for at least one module for generating training data. While a certain task is performed in the electronic device 100, prompts and input data may be generated or input step by step according to a process, and may be executed by a generative model of the electronic device 100.

According to an embodiment of the disclosure, the one or more instructions, when executed by the at least one processor 120, may cause the electronic device 100 to perform, by using a first generative model, inference a predefined number of times for the same input sequence. The first generative model may be a large language model on which SFT training has been performed. The input sequence may be pre-prepared in the electronic device 100 or automatically generated by a system of the electronic device 100, and the input data of the input sequence may be an input received from the user.

An inference module 121 of the processor 120 may adjust settings related to the degree of freedom of an output of the first generative model such that various inference results are generated for the same input sequence. The inference module 121 may obtain an input sequence including a prompt and input data. The inference module 121 may perform, by using the first generative model, inference for a predefined number of times for the same input sequence, and may output an inference result including the predefined number of inferences.

According to an embodiment of the disclosure, the one or more instructions, when executed by the at least one processor 120, may cause the electronic device 100 to evaluate, by using a second generative model, a preference for an inference result of the first generative model. The second generative model may be a large language model that performs preference evaluation based on an input sequence providing the inference result of the first generative model and evaluation data.

An evaluation module 123 of the processor 120 may obtain an input sequence providing an inference result of the first generative model and evaluation data. The input sequence may include, as input data, the inference result of the first generative model in a prompt including the evaluation data. The evaluation module 123 may input the inference result of the first generative model and the evaluation data to the second generative model to evaluate the preference for the inference result of the first generative model. The evaluation module 123 may output a high-score or high-rank evaluation for an inference corresponding to a preferred response, in the inference result of the first generative model, and may output a low-score or low-rank evaluation for an inference corresponding to a non-preferred response, in the inference result of the first generative model.

According to an embodiment of the disclosure, the one or more instructions, when executed by the at least one processor 120, may cause the electronic device 100 to, based on an evaluation result, select, from the inference result, a plurality of response pairs each including a non-preferred response and a preferred response. A training data generation module 125 of the processor 120 may select, from the inference result including the predefined number of inferences, a plurality of response pairs each including an inference evaluated as a non-preferred response and an inference evaluated as a preferred response.

According to an embodiment of the disclosure, the one or more instructions, when executed by the at least one processor 120, may cause the electronic device 100 to generate preference training data by processing the plurality of response pairs. The training data generation module 125 of the processor 120 may process at least one of the non-preferred response or the preferred response included in each of the plurality of response pairs.

For example, the training data generation module 125 of the processor 120 may process the non-preferred response comprised in each of the plurality of response pairs by identifying, by using the second generative model, a portion of the non-preferred response of the response pair that incurs a point deduction in evaluation, and filtering the non-preferred response such that the portion that incurs the point deduction remains. The training data generation module 125 of the processor 120 may process the preferred response comprised in each of the plurality of response pairs by identifying, by using the second generative model, a portion of the preferred response of the response pair that incurs a point deduction in evaluation, filtering the preferred response such that the portion that incurs the point deduction is removed, and supplementing the filtered preferred response with a portion that incurs a point addition in evaluation. The training data generation module 125 of the processor 120 may evaluate, by using the second generative model, a preference for the supplemented preferred response, and may determine, based on an evaluation result for the supplemented preferred response, whether to further apply the process for processing the preferred response to the supplemented preferred response.

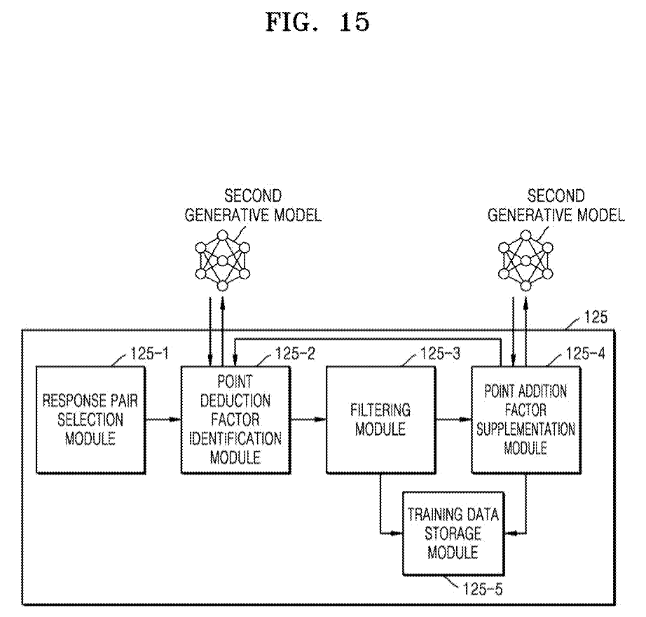

FIG. 15 is a block diagram illustrating in detail an operation of the training data generation module 125 in the electronic device 100 for generating training data for preference optimization training, according to an embodiment of the disclosure.

The training data generation module 125 may include a response pair selection module 125-1, a point deduction factor identification module 125-2, a filtering module 125-3, a point addition factor supplementation module 125-4, and a training data storage module 125-5, but is not limited to the names of respective modules. Unlike the illustration of FIG. 15, some modules may form an integrated module, or may be separated into more detailed modules.

The response pair selection module 125-1 may determine, as a preferred response, an inference result of the first generative model that has received the best evaluation score, in the evaluation result of the second generative model. The response pair selection module 125-1 may determine, as non-preferred responses, an inference result that has received the minimum evaluation score and an inference result that has received the most frequent evaluation score, in the evaluation result of the second generative model. The response pair selection module 125-1 may select a first response pair and a second response pair, the first response pair including a non-preferred response with the minimum value of the evaluation result and a preferred response with the maximum value of the evaluation result, and the second response pair including a non-preferred response with the most frequent value of the evaluation result and a preferred response with the maximum value of the evaluation result.

The point deduction factor identification module 125-2 may identify, by using the second generative model, a portion that incurs a point deduction in evaluation in the non-preferred response included each of the plurality of response pairs. For example, the point deduction factor identification module 125-2 may include a sentence of the non-preferred response in a prompt as input data, and may identify, by using the second generative model, a first portion of the sentence of the non-preferred response that incurs a point deduction.

The point deduction factor identification module 125-2 may identify, by using the second generative model, a portion that incurs a point deduction in evaluation in the preferred response included each of the plurality of response pairs. For example, the point deduction factor identification module 125-2 may include a sentence of the preferred response in a prompt as input data, and may identify, by using the second generative model, a first portion of the sentence of the preferred response that incurs a point deduction.

The filtering module 125-3 may filter the non-preferred response such that the portion that incurs the point deduction remains. For example, the filtering module 125-3 may retain, as the non-preferred response, portions up to the first portion that incurs a point deduction in the sentence of the non-preferred response. The filtering module 125-3 may retain, as the non-preferred response, sentences up to the sentence including the first portion that incurs a point deduction, among the sentences corresponding to the non-preferred response. The final processed non-preferred response may be stored as preference training data for preference optimization training in the training data storage module 125-5.

The filtering module 125-3 may filter the preferred response such that the portion that incurs the point deduction is removed. For example, the filtering module 125-3 may retain, as the preferred response, only portions up to the first portion that incurs a point deduction in the sentence of the preferred response, and may exclude, from the preferred response, portions after the first portion that incurs a point deduction. The filtering module 125-3 may retain, as the preferred response, sentences up to the sentence including the first portion that incurs a point deduction, among the sentences corresponding to the preferred response.

The point addition factor supplementation module 125-4 may supplement the filtered preferred response with a portion that incurs a point addition in evaluation. The point addition factor supplementation module 125-4 may generate a supplemented preferred response by including a sentence of the filtered preferred response in a prompt as input data, and adding a sentence that incurs a point addition after the sentence of the filtered preferred response by using the second generative model. The point addition factor supplementation module 125-4 may evaluate a preference for the supplemented preferred response by using the second generative model. For example, the point addition factor supplementation module 125-4 may include a sentence of the supplemented preferred response in a prompt as input data, and may evaluate a preference for the sentence of the supplemented preferred response by using the second generative model. The point addition factor supplementation module 125-4 may determine, based on an evaluation result for the supplemented preferred response, whether to further apply the process of processing the preferred response to the supplemented preferred response. The point addition factor supplementation module 125-4 may terminate the process of processing the preferred response when an evaluation result of the preference for the supplemented preferred response satisfies a predefined criterion. The final processed preferred response may be stored as preference training data for preference optimization training in the training data storage module 125-5.

As illustrated in FIG. 14, when a training module 127 is implemented in the processor 120, the training module 127 may perform preference optimization training for the first generative model by using preference training data generated by the training data generation module 125. The preference training data generated by the training data generation module 125 may be generated based on an inference result of the first generative model and a preference evaluation result for the inference result of the first generative model, and thus may be most effective for preference optimization training of the first generative model.

An embodiment of the disclosure may be implemented in the form of a recording medium including computer-executable instructions, such as a program module executed by a computer. A computer-readable medium may be any available medium accessible by a computer, and may include both volatile and non-volatile media, and separable and non-separable media. In addition, the computer-readable medium may include a computer storage medium and a communication medium. The computer storage media may include both volatile and non-volatile media, and separable and non-separable media implemented in any method or technology for storage of information such as computer-readable instructions, data structures, program modules, or other data. The communication medium may typically include other data in modulated data signals, such as computer-readable instructions, data structures, or program modules.

In addition, the computer-readable storage medium may be provided in the form of a non-transitory storage medium. In this regard, the term "non-transitory storage medium" simply indicates that the storage medium is a tangible device and does not include a signal (e.g., an electromagnetic wave), and this term does not differentiate between a case where data is semi-permanently stored in the storage medium and a case where data is temporarily stored in the storage medium. For example, the "non-transitory storage medium" may include a buffer in which data is temporarily stored.

According to an embodiment of the disclosure, the method according to an embodiment of the disclosure may be provided by being included in a computer program product. The computer program product may be traded as a product between a seller and a buyer. The computer program product may be distributed in the form of a machine-readable storage medium (e.g., a compact disc read-only memory (CD-ROM)), or may be distributed online (e.g., downloaded or uploaded) through an application store or directly between two user devices (e.g., smartphones). In the case of online distribution, at least a portion of the computer program product (e.g., a downloadable application) may be temporarily stored in a machine-readable storage medium, such as memory of a manufacturer's server, an application store's server, or a relay server, or may be temporarily generated.

According to an aspect of the disclosure, a method of generating training data for preference optimization training includes performing, by using a first generative model, inference a predefined number of times by inputting a same input sequence into the first generative model the predefined number of times; evaluating, by using a second generative model, a preference for an inference result of the first generative model; based on an evaluation result with respect to the evaluating, selecting, from the inference result, a plurality of response pairs each comprising a non-preferred response and a preferred response; and generating training data by processing the plurality of response pairs.

The selecting of the plurality of response pairs comprises selecting a first response pair and a second response pair, the first response pair comprising a non-preferred response with a minimum value of the evaluation result and a preferred response with a maximum value of the evaluation result, and the second response pair comprising a non-preferred response with a most frequent value of the evaluation result and a preferred response with the maximum value of the evaluation result.

The generating of the training data comprises processing the non-preferred response comprised in each of the plurality of response pairs by: identifying, by using the second generative model, a portion of the non-preferred response that incurs a point deduction in evaluation; and filtering the non-preferred response such that a portion of the non-preferred response that does not incur the point deduction is removed and the portion of the non-preferred response that incurs the point deduction remains.

The generating of the training data includes processing the preferred response comprised in each of the plurality of response pairs by: identifying, by using the second generative model, a portion of the preferred response that incurs a point deduction in evaluation; filtering the preferred response such that a portion of the preferred response that does not incur the point deduction remains and the portion of the preferred response that incurs the point deduction is removed; and supplementing the filtered preferred response with a portion that incurs a point addition in the evaluation.

The processing of the preferred response further includes: evaluating, by using the second generative model, a preference for the supplemented preferred response; and determining, based on a result of evaluating the preference for the supplemented preferred response, whether to apply the processing of the preferred response to the supplemented preferred response.

The performing of the inference comprises adjusting one or more settings related to a degrees of freedom of an output of the first generative model such that various inference results are generated for the same input sequence.

The first generative model comprises a large language model on which supervised fine-tuning (SFT) training has been performed, and the second generative model comprises a large language model configured to perform preference evaluation based on an input sequence providing the inference result of the first generative model and evaluation data.

According to an aspect of the disclosure, a non-transitory computer-readable recording medium having instructions stored thereon, which when executed by a processor in an electronic device cause the processor to execute a method including: performing, by using a first generative model, inference a predefined number of times by inputting a same input sequence into the first generative model the predefined number of times; evaluating, by using a second generative model, a preference for an inference result of the first generative model; based on an evaluation result with respect to the evaluating, selecting, from the inference result, a plurality of response pairs each comprising a non-preferred response and a preferred response; and generating training data by processing the plurality of response pairs.

According to an aspect of the disclosure, an electronic device for generating training data for preference optimization training includes: memory comprising one or more storage media storing one or more instructions; and at least one processor comprising processing circuitry, in which the one or more instructions, when executed by the at least one processor individually or collectively, cause the electronic device to: perform, by using a first generative model, inference a predefined number of times by inputting a same input sequence into the first generative model the predefined number of times; evaluate, by using a second generative model, a preference for an inference result of the first generative model; based on an evaluation result with respect to the evaluating, select, from the inference result, a plurality of response pairs each comprising a non-preferred response and a preferred response; and generate training data by processing the plurality of response pairs.

The one or more instructions, when executed by the at least one processor individually or collectively, cause the electronic device to select a first response pair and a second response pair, the first response pair comprising a non-preferred response with a minimum value of the evaluation result and a preferred response with a maximum value of the evaluation result, and the second response pair comprising a non-preferred response with a most frequent value of the evaluation result and a preferred response with the maximum value of the evaluation result.

The one or more instructions, when executed by the at least one processor individually or collectively, cause the electronic device to process the non-preferred response comprised in each of the plurality of response pairs by identifying, by using the second generative model, a portion of the non-preferred response that incurs a point deduction in evaluation, and filtering the non-preferred response such that a portion of the non-preferred response that does not incur the point deduction is removed and the portion of the non-preferred response that incurs the point deduction remains.

The one or more instructions, when executed by the at least one processor individually or collectively, cause the electronic device to process the preferred response comprised in each of the plurality of response pairs by identifying, by using the second generative model, a portion of the preferred response that incurs a point deduction in evaluation, filtering the preferred response such that a portion of the preferred response that does not incur the point deduction remains and the portion that incurs the point deduction is removed, and supplementing the filtered preferred response with a portion that incurs a point addition in the evaluation.

The one or more instructions, when executed by the at least one processor individually or collectively, cause the electronic device to evaluate, by using the second generative model, a preference for the supplemented preferred response, and determine, based on a result of evaluating the preference for the supplemented preferred response, whether to apply a process of refining the preferred response to the supplemented preferred response.

The one or more instructions, when executed by the at least one processor individually or collectively, cause the electronic device to adjust one or more settings related to a degrees of freedom of an output of the first generative model such that various inference results are generated for the same input sequence.

The first generative model includes a large language model on which supervised fine-tuning (SFT) training has been performed, and the second generative model comprises a large language model configured to perform preference evaluation based on an input sequence providing the inference result of the first generative model and evaluation data.

The above descriptions of the disclosure are provided for illustrative purposes only, and it will be understood by one of ordinary skill in the art that various changes in form and details may be readily made therein without departing from the spirit and scope of the disclosure. Accordingly, it should be understood that that the above-described embodiment of the disclosure is illustrative in all respects and does not limit the scope of the disclosure. For example, each component described to be of a single type may be implemented in a distributed manner and, likewise, components described as being distributed may be implemented in a combined manner.

The scope of the disclosure is defined by the appended claims rather than the detailed description, and it should be understood that all changes or modifications within the scope of the appended claims and their equivalents are included in the scope of the disclosure.

What is claimed is:

1. A method of generating training data for preference optimization training, the method comprising:
performing, by using a first generative model, inference a predefined number of times by inputting a same input sequence into the first generative model the predefined number of times;
evaluating, by using a second generative model, a preference for an inference result of the first generative model;
based on an evaluation result of the evaluating, selecting, from the inference result, a plurality of response pairs, each of the plurality of response pairs comprising a non-preferred response and a preferred response; and
generating training data by processing the plurality of response pairs.

2. The method of claim 1, wherein the selecting of the plurality of response pairs comprises selecting a first response pair and a second response pair, the first response pair comprising a non-preferred response with a minimum value of the evaluation result and a preferred response with a maximum value of the evaluation result, and the second response pair comprising a non-preferred response with a most frequent value of the evaluation result and a preferred response with the maximum value of the evaluation result.

3. The method of claim 1, wherein the generating of the training data comprises processing the non-preferred response comprised in each of the plurality of response pairs by:
identifying, by using the second generative model, a portion of the non-preferred response that incurs a point deduction in evaluation; and
filtering the non-preferred response such that a portion of the non-preferred response that does not incur the point deduction is removed and the portion of the non-preferred response that incurs the point deduction remains.

4. The method of claim 1, wherein the generating of the training data comprises processing the preferred response comprised in each of the plurality of response pairs by:
identifying, by using the second generative model, a portion of the preferred response that incurs a point deduction in evaluation;
filtering the preferred response such that a portion of the preferred response that does not incur the point deduction remains and the portion of the preferred response that incurs the point deduction is removed; and
supplementing the filtered preferred response with a portion that incurs a point addition in the evaluation.

5. The method of claim 4, wherein the processing of the preferred response further comprises:
evaluating, by using the second generative model, a preference for the supplemented preferred response; and
determining, based on a result of the evaluating the preference for the supplemented preferred response, whether to apply the processing of the preferred response to the supplemented preferred response.

6. The method of claim 1, wherein the performing of the inference comprises adjusting one or more settings related to a degrees of freedom of an output of the first generative model such that different inference results are generated for the same input sequence.

7. The method of claim 1, wherein the first generative model comprises a large language model on which supervised fine-tuning (SFT) training has been performed, and
wherein the second generative model comprises a large language model configured to perform preference evaluation based on an input sequence providing the inference result of the first generative model and evaluation data.

8. A non-transitory computer-readable recording medium having instructions stored thereon, which when executed by at least one processor of an electronic device, cause the electronic device to perform a method of generating training data for preference optimization training, the method comprising:
performing, by using a first generative model, inference a predefined number of times by inputting a same input sequence into the first generative model the predefined number of times;
evaluating, by using a second generative model, a preference for an inference result of the first generative model;
based on an evaluation result of the evaluating, selecting, from the inference result, a plurality of response pairs, each of the plurality of response pairs comprising a non-preferred response and a preferred response; and
generating training data by processing the plurality of response pairs.

9. An electronic device for generating training data for preference optimization training, the electronic device comprising:
memory comprising one or more storage media storing one or more instructions; and
at least one processor comprising processing circuitry,
wherein the one or more instructions, when executed by the at least one processor individually or collectively, cause the electronic device to:
perform, by using a first generative model, inference a predefined number of times by inputting a same input sequence into the first generative model the predefined number of times;
evaluate, by using a second generative model, a preference for an inference result of the first generative model;
based on an evaluation result of the evaluating, select, from the inference result, a plurality of response pairs, each of the plurality of response pairs comprising a non-preferred response and a preferred response; and
generate training data by processing the plurality of response pairs.

10. The electronic device of claim 9, wherein the one or more instructions, when executed by the at least one processor individually or collectively, cause the electronic device to select a first response pair and a second response pair, the first response pair comprising a non-preferred response with a minimum value of the evaluation result and a preferred response with a maximum value of the evaluation result, and the second response pair comprising a non-preferred response with a most frequent value of the evaluation result and a preferred response with the maximum value of the evaluation result.

11. The electronic device of claim 9, wherein the one or more instructions, when executed by the at least one processor individually or collectively, cause the electronic device to process the non-preferred response comprised in each of the plurality of response pairs by identifying, by using the second generative model, a portion of the non-preferred response that incurs a point deduction in evaluation, and filtering the non-preferred response such that a portion of the non-preferred response that does not incur the point deduction is removed and the portion of the non-preferred response that incurs the point deduction remains.

12. The electronic device of claim 9, wherein the one or more instructions, when executed by the at least one processor individually or collectively, cause the electronic device to process the preferred response comprised in each of the plurality of response pairs by identifying, by using the second generative model, a portion of the preferred response that incurs a point deduction in evaluation, filtering the preferred response such that a portion of the preferred response that does not incur the point deduction remains and the portion that incurs the point deduction is removed, and supplementing the filtered preferred response with a portion that incurs a point addition in the evaluation.

13. The electronic device of claim 12, wherein the one or more instructions, when executed by the at least one processor individually or collectively, cause the electronic device to evaluate, by using the second generative model, a preference for the supplemented preferred response, and determine, based on a result of evaluating the preference for the supplemented preferred response, whether to apply a process of refining the preferred response to the supplemented preferred response.

14. The electronic device of claim 9, wherein the one or more instructions, when executed by the at least one processor individually or collectively, cause the electronic device to adjust one or more settings related to a degrees of freedom of an output of the first generative model such that different inference results are generated for the same input sequence.

15. The electronic device of claim 9, wherein the first generative model comprises a large language model on which supervised fine-tuning (SFT) training has been performed, and
wherein the second generative model comprises a large language model configured to perform preference evaluation based on an input sequence providing the inference result of the first generative model and evaluation data.
